(19) United States
(12) Patent Application Publication
(10) Pub. No.: US 2023/0375053 A1
(43) Pub. Date: Nov. 23, 2023

(54) DISK BRAKE SYSTEM WITH A SHELL

(71) Applicant: HL MANDO CORPORATION, Gyeonggi-do (KR)

(72) Inventors: Hatem SHAHIN, Pfaffenhofen (DE); Kai Braun, Friedrichsdorf (DE); Lothar Wagner, Simmern (DE)

(21) Appl. No.: 18/198,287

(22) Filed: May 17, 2023

(30) Foreign Application Priority Data
May 17, 2022 (DE) 102022204897.0

(51) Int. Cl. F16D 65/00

(52) U.S. Cl. CPC F16D 65/0031; F16D 65/0006; F16D 2250/0084

(57) ABSTRACT

The invention relates to a disk brake system for a vehicle, comprising a brake disk, a caliper and a shell, the shell at least partially encasing the brake disk, and optionally the caliper, at an axially outer side and/or an axially inner side and/or a circumferentially outer side.

### CROSS-REFERENCE TO RELATED APPLICATION

This application is based on and claims priority under 35 U.S.C. § 119 to German Patent Application No. 102022204897.0, filed on May 17, 2022 in the German Patent and Trade Mark Office, the disclosures of which are incorporated herein by reference.

### TECHNICAL FIELD

The present invention is in the field of mechanical engineering. It relates to vehicle technology, in particular vehicle brakes. It is proposed to provide a disk brake system with a shell.

### BACKGROUND

Disk brake systems are efficient brake systems commonly used in vehicles, which feature a brake disk and brake pads that are pressed against the brake disk for braking.

Even though they have been used and improved over the course of a long time, they continue to have some known disadvantages that have not been satisfactorily solved.

They typically emit noises, such as squeal noises, where the brake disc can act as a resonator or amplifier and emits brake noise into to vehicle and into the environment.

They can emit brake dust which may be critical to people's health.

They can show unstable dynamic behaviour and braking performance due to weather or humidity.

They may be subject to corrosion, which can cause a decline in performance.

### SUMMARY

It is an object of the present invention to solve at least some of the above-mentioned problems and thus provide an improved brake system.

This is achieved by a disk brake system according to claim 1. Advantageous embodiments can be found in the dependent claims and in the following description and the figures.

Correspondingly, a disk brake system for a vehicle comprises a brake disk, a caliper and a shell. The shell at least partially encases the brake disk and optionally the caliper, at an axially outer side and/or an axially inner side and/or a circumferentially outer side.

By having this encasing, noise emitted from the brake disk is dampened, and the brake parts are protected.

The shell may typically be arranged in a manner distanced from the brake disk. The shell may for instance have a thickness of between 0.5 mm and 2 mm. It may for instance comprise metal and/or plastic.

In an embodiment, the shell may be configured to rotate along with the brake disk. Therein, the shell may for example be attached to a wheel and/or an axle. In particular, the shell may for example be attached to a wheel hub and/or a wheel rim and/or a wheel bearing.

The shell may for instance comprise a first outer segment that is configured to cover at least a portion of the axially outer side of the brake disk. For example, the first outer segment may be connected to the wheel hub and/or the rim. In some cases, it is connected to the wheel hub and/or the rim in a removable manner.

Additionally or alternatively, the shell may comprise a first inner segment, configured to cover at least a portion of the axially inner side of the brake disk. The first inner segment may optionally be connected to the first outer segment, for instance in a removable manner. Additionally or alternatively, the first inner segment may be connected to the rim and/or to an axle, for instance in a removable manner.

The shell may comprise further outer segments and/or further inner segments. They may be connected to the respective first segments.

If the first outer segment and the first inner segment are provided, they may be removably connected to each other.

In an embodiment, the shell is configured to be non-rotating, such that the brake disk rotates within the shell. Therein, the shell may for instance be configured to be attached to the caliper and/or a carrier for the caliper and/or a wheel arch.

The shell may for instance comprise at least a first inner segment configured to cover at least a portion of the axially inner side of the brake disk. The first inner segment may be connected to the caliper and/or to the carrier of the caliper and/or to the wheel arch. This connection may in each case be carried out in a removable manner.

The shell may comprise a coating layer for adhesion of brake dust.

The shell may comprise magnetic inserts for collecting metallic brake dust.

The shell may comprise at least two segments that are connected to each other. The at least two segments may for instance be a first inner segment and a second inner segment, and/or a first inner segment and a first outer segment, and/or a first outer segment and a second outer segment.

The at least to segments may for instance be connected to each other by an adhesive and/or by at least one bolt and/or by at least one screw.

In an example, at least two of the at least two segments are made of a different material from each other.

According to possible examples, the shell comprises for instance an inner portion, which covers at least a portion of the axially inner side of the brake disk, and/or an outer portion, which covers at least a portion of the axially outer side of the brake disk. The aforementioned inner segments may be seen as forming the inner portion of the shell, which covers at least a portion of the axially inner side of the brake disk. Additionally or alternatively, the aforementioned outer segments may be seen as forming the outer portion of the shell, which covers at least a portion of the axially outer side of the brake disk.

In an example, the shell comprises at least to layers, at least in a section of the shell. In an example, the at least two layers are made of different materials from each other.

The shell may for instance be transparent, at least in a section.

The shell may comprise a cleaning arrangement. In an example, the shell comprises at least one cleaning opening, for rinsing an interior space of the shell and/or for applying suction to the inner space of the shell.

In an example, a distance between an inner surface of the shell and the brake disk is at least 10 mm.

In an example, the shell only partially encases the axially outer side and/or the axially inner side of the brake disk, leaving at least 25% of an area of the axially inner side and/or an area of the axially outer side of the brake disk exposed.

The disk brake system having the shell may for instance be configured as a brake system for an electric vehicle and/or as a brake system for a rear axle.

### BRIEF DESCRIPTION OF DRAWINGS

In the following, the invention will be explained in an exemplary fashion with reference to the appended figures. Therein,

FIGS. 1-4 show components of a disk brake system,

FIG. 5 illustrates emission of brake noise from a disk brake,

FIG. 6 shows a disk brake system with a shell,

FIGS. 7, 8 show disk brake systems with shells made of two different materials,

FIGS. 9, 10 show cleaning systems for the shell of the disk brake system,

FIGS. 11-16 show different embodiments of the shell, configured as a rotating shell,

FIGS. 17-20 illustrate attachment of rotating shells,

FIGS. 21-26 show embodiments of the shell, configured as a non-rotating shell,

FIGS. 27, 28 illustrate a position of the shell with respect to a wheel, and

FIGS. 29-44 show ways of carrying out an inner portion and an outer portion of the shell.

### DETAILED DESCRIPTION

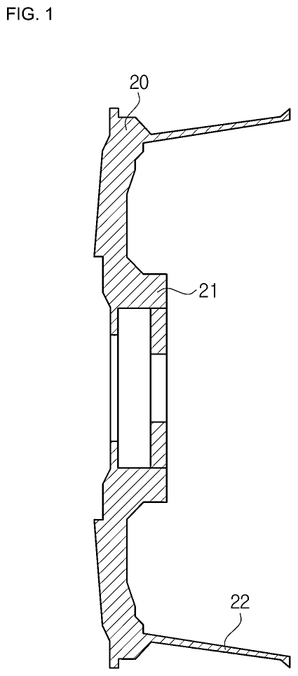

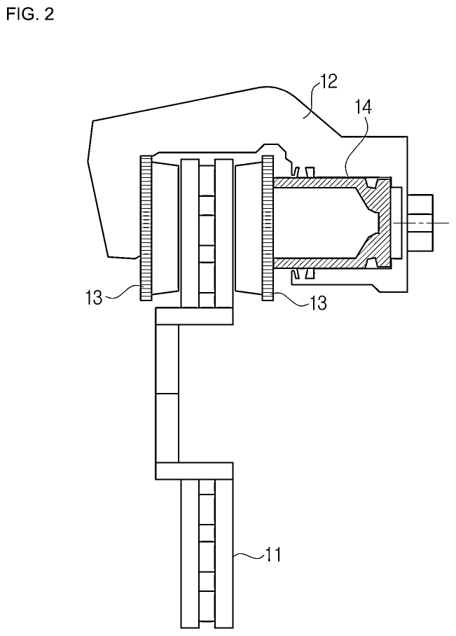

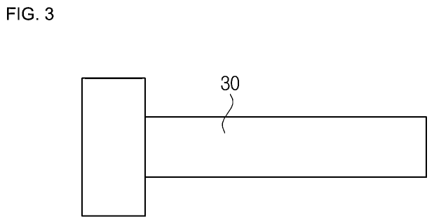

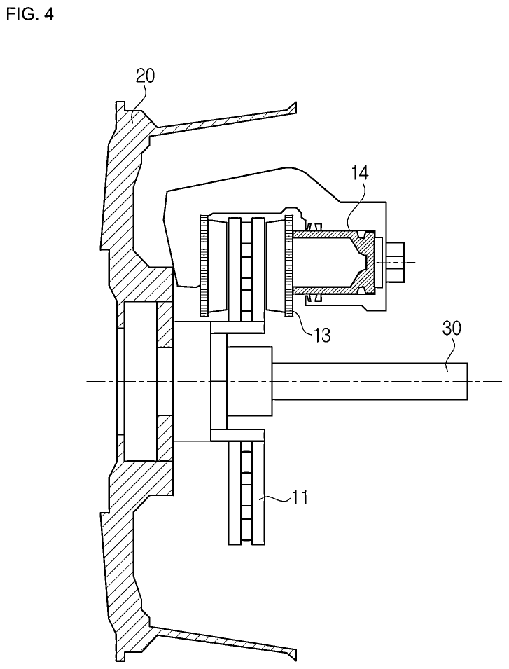

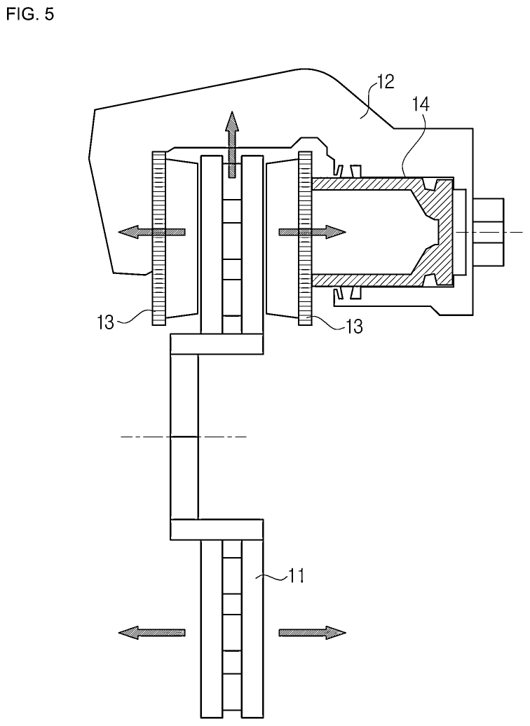

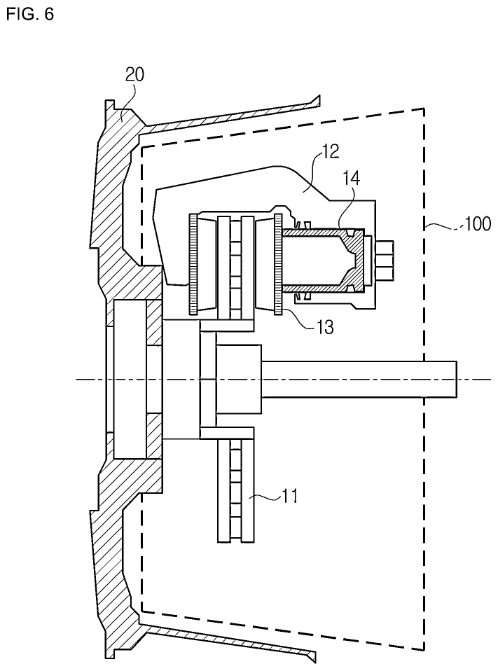

FIGS. 1-4 show components of a disk brake system for a vehicle. FIG. 1 shows a wheel 20, with a central wheel hub 21, and rim 22 for bearing a tire on its outer side. FIG. 2 shows a brake disk 11 that is connectible to the wheel 20, and a caliper 12 holding two opposed brake pads 13 that can be pressed against the brake disk 11 for braking, by way of a piston 14. FIG. 3 shows an axle 30, to which the wheel 20 and the brake disk 11 are to be attached. FIG. 4 shows the components of FIGS. 1-3 in an assembled state. The brake disk 11 rotates along with the wheel 20. When the brakes are applied, the brake pads 13 are pressed against the brake disk 11 by way of the piston 14, to create friction and decelerate the rotating movement. When the brakes are released, the brake pads 13 retract from the brake disk 11.

FIG. 2 shows the brake disk 11 and the caliper 12 with the piston 14 and the brake pads 13. Arrows indicate emission of brake noise. I.e., the components of the brake system, including the brake disk 11, vibrate and resonate and give rise to undesired noise. Moreover, brake dust is generated as the brake pads 13 wear down. In the following, a concept is described which helps to protect an environment of the vehicle from noise and brake dust. The disk brake system, at which this concept may be applied, may for instance be a brake system for an electric vehicle and/or a brake system for a rear axle of a vehicle.

FIG. 3 shows a disk brake system which has been modified according to the present application, to protect the environment from noise and brake dust. The disk brake system comprises the brake disk 11, the caliper 12, and a shell 100. Said shell 100 encases the brake disk 11 and the caliper 12, at an axially outer side, an axially inner side, and at a circumferentially outer side, providing a hull to all sides, shielding noise, and collecting any dust emitted from the brake pads 13. A distance between an inner surface of the shell 11 and the brake disk 11 is at least 10 mm.

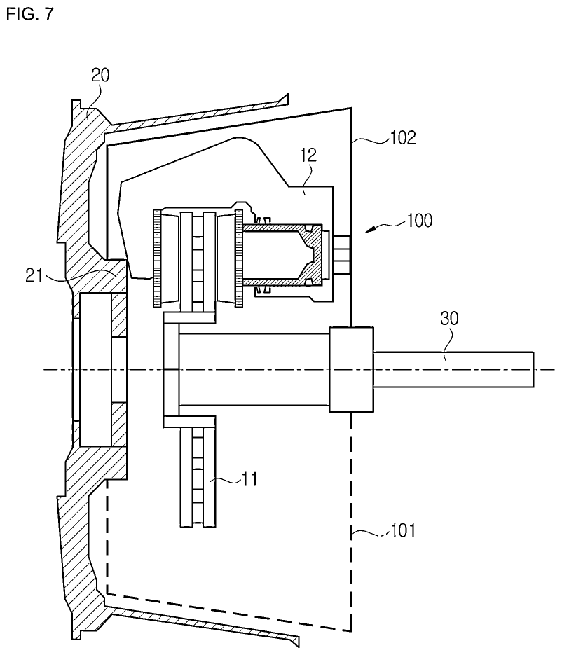

FIG. 7 shows an embodiment of the brake system with the shell 100, wherein the shell 100 comprises two parts, made of a different material from each other, or from the same material. The shell 100 comprises a first half-shell 101, covering half of the brake disk 11, at the axially outer side, at the axially inner side, and at the circumferentially outer side. The shell 100 furthermore comprises a second half-shell 102, covering the remaining half of the brake disk 11, at the axially inner side, and at the circumferentially outer side. The two half-shells 101, 102, together, provide a hull to all sides. The two half shells 101, 102 may be removably connected to each other, allowing assembly and disassembly of the shell 100. Moreover, both half-shells 101, 102 may optionally be connected to the wheel hub 21 and/or the axle 30. In the position shown in the Figure, the first half-shell 101 covers the upper half, and the second half shell 102 covers the lower half. When the wheel 20 and brake disk 11 rotate, the half shells 101, 102 also rotate and thus change their positions.

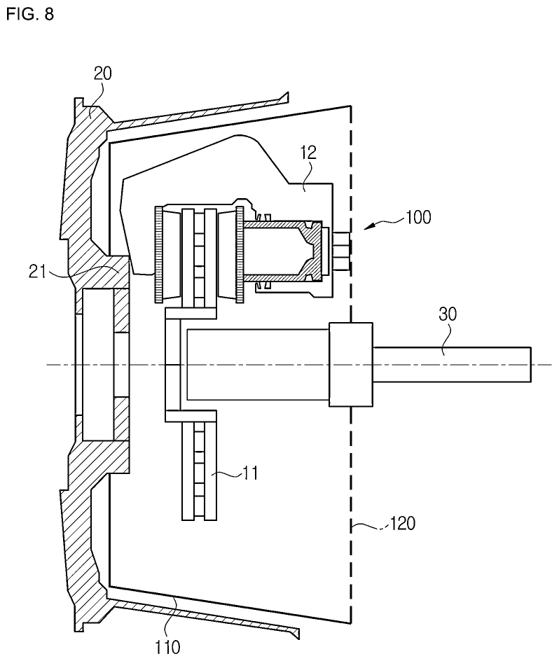

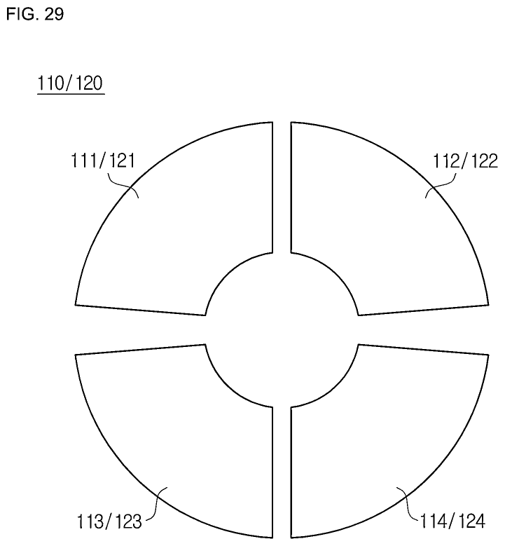

FIG. 8 shows the disk brake system with the shell 100, wherein the shell 100 comprises an outer portion 110 that covers the axially outer side of the brake disk, and also extends over the outer circumferential side of the brake disk 11 and the caliper 12. The outer portion 110 is connected to the wheel hub 21. The shell 100 furthermore comprises an inner portion 120, covering the brake disk 11 and the caliper 12 at the axially inner side, and providing a complete hull for the brake disk 11, together with the outer portion 110. The inner portion 120 is removably connected to the outer portion 110 and to the axle 30, allowing assembly and disassembly of the shell 100, enabling for instance access to the brake disk 11 and the caliper 12, or enabling cleaning of the shell 100. The inner portion 120 and the outer portion 110 may be made of the same material or of different materials from each other. The inner portion 120 and the outer portion 110 may each comprise one or more segments 111, 112, 113, 114, 121, 122, 123, 124, as will be explained for example in the context of FIGS. 29-44.

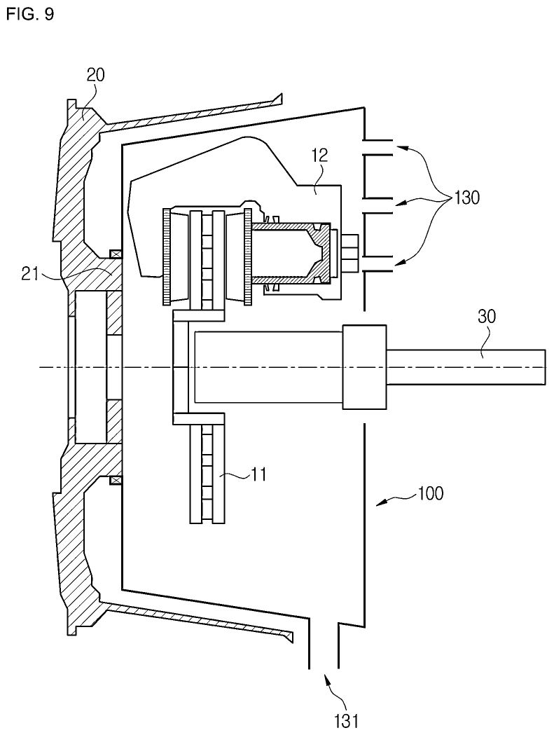

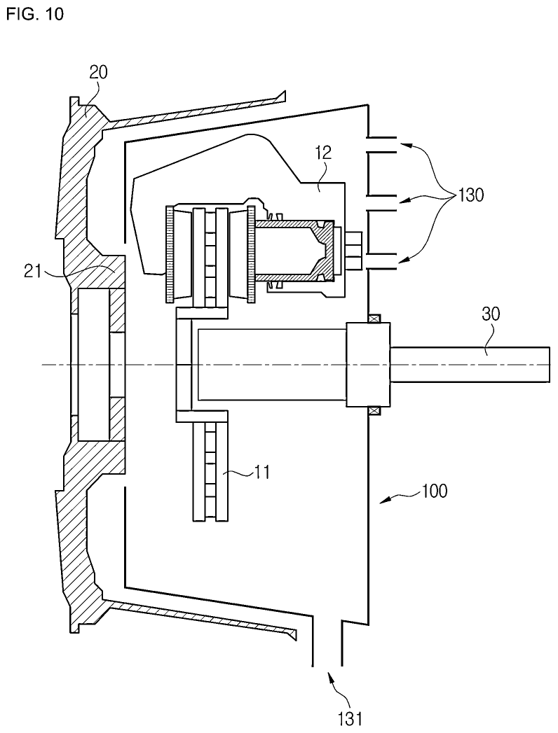

FIGS. 9, 10 show the disk brake system with the shell 100, wherein the shell 100 comprises rinsing and cleaning facilities. Therein, several cleaning openings are provided in the shell 100. The cleaning openings include a plurality of rinsing openings 130 which allow rinsing an interior space of the shell 100, and at least one suction opening 131 is provided, at which suction may be applied, so that dust or dirt may be sucked out. By way of this, brake dust may be removed from the interior of the shell 100. In the embodiment of FIG. 9, the shell 100 is attached to the wheel hub 21, and not to the axle 30. In the embodiment of FIG. 10, the shell is attached to the axle 30, but not to the wheel 20. It is also possible to connect the shell 100 to both the wheel 20 and the axle 30.

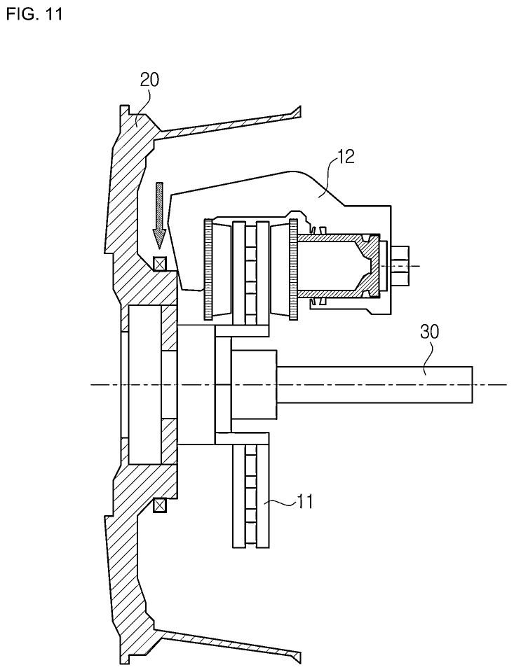

FIGS. 11-16 illustrate different embodiments of the shell 100, wherein the shell 100 covers different portions of the brake disk 11, providing a partial or a full hull for the brake disk 11. In these embodiments, the shell 100 rotates along with the brake disk 11.

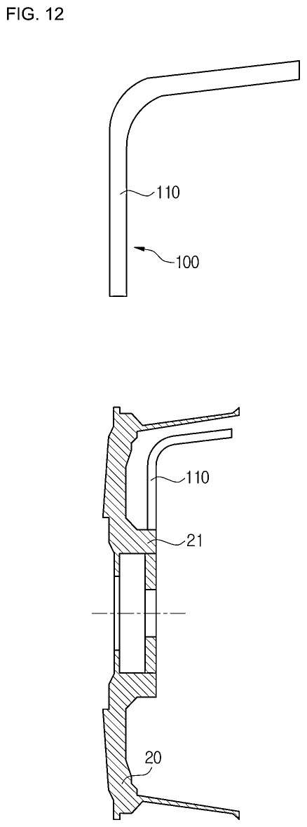

FIG. 11 illustrates the basic setup including the wheel 20, the axle 30, and the brake disk 11 with the caliper 12. Therein, an arrow highlights the position where the shell 100 may be attached to the wheel hub 21 of the wheel 20, according to the embodiments shown in FIGS. 12-15.

FIGS. 12-16 show, at the top, in a schematic fashion, inner and outer portions 110, 120 of the shells 100 according to the various embodiments. At the bottom, the figures illustrate how these portions 110, 120 of the shells 100 may be connected to the wheel 20. The portions 110, 120 may in each case be composed of one or more segments (cf. FIGS. 29-44).

FIG. 12 shows that the shell 100 comprises an outer portion 110, covering half of an axially outer side of the brake disk 11 and covering a part of a circumferentially outer side of the brake disk 11. The shell 100 thus provides a quarter hull for the brake disk 11, leaving about 75% of the brake disk 11 exposed.

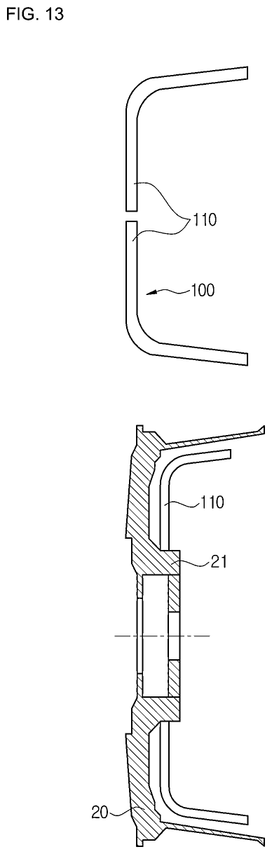

FIG. 13 shows that the shell 100 comprises an outer portion 110, covering all of an axially outer side of the brake disk 11 and a part of an outer circum-ferential side of the brake disk 11, and thus also covering the caliper 12 at the axially outer side and the circumferentially outer side. This shell 100 provides a half hull for the brake disk 11, leaving about 50% of the brake disk 11 exposed.

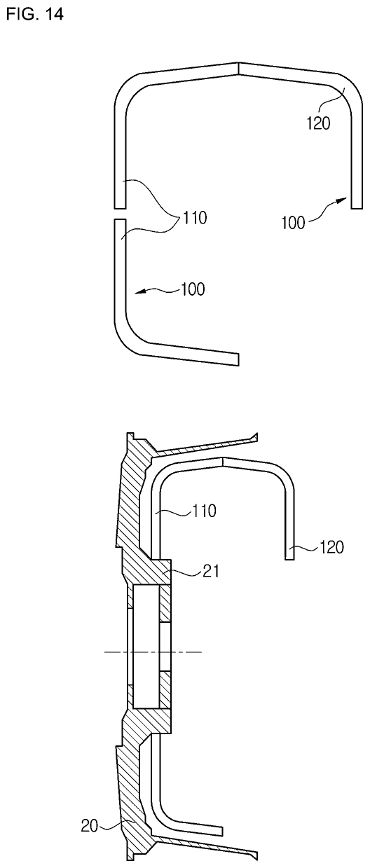

FIG. 14 shows that the shell 100 comprises, in addition to an outer portion 110 like the one shown in FIG. 13, an inner portion 120. The inner portion 120 covers half of an axially inner side of the brake disk 11. Consequently, the caliper 12 is also partly covered (depending on the position of the shell 100, the inner side of the clipper 12 is covered or exposed). The inner portion 120 is connected to the outer portion 110, which in turn is connected to the wheel 20. The outer portion 110 and the inner portion 120, together, form a three-quarter hull for the brake disk 11, leaving 25% of the brake disk 11 exposed.

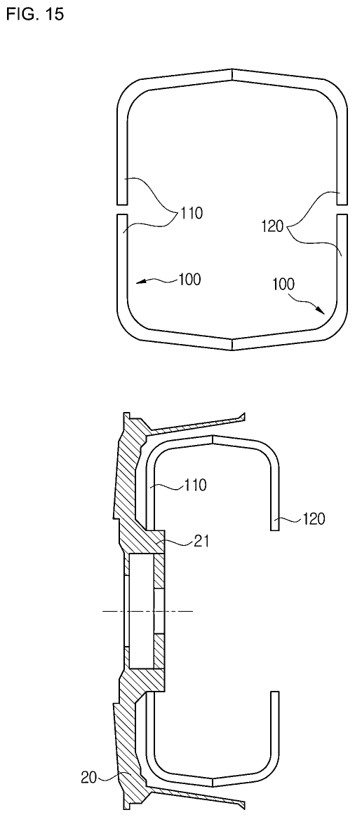

FIG. 15 shows that the shell comprises an outer portion 110 covering all of the axially outer side of the brake disk 11 and the caliper 12, and a part of an outer circumferential side of the brake disk 11 and the caliper 12. The shell 100 furthermore comprises an inner portion 120 covering an axially inner side of the brake disk 11 and of the caliper 12, and the remaining part of the outer circumferential side of the brake disk 11 and of the caliper 12. The outer portion 110 and the inner portion 120, together, form a full hull for the brake disk and caliper, wherein an axle may be passed through a central opening within the inner portion 120. The outer portion 110 is connected to the wheel hub 21, and the inner portion 120 is connected to the outer portion 110. Optionally, the inner portion 120 may be connected or connectible to the axle 30.

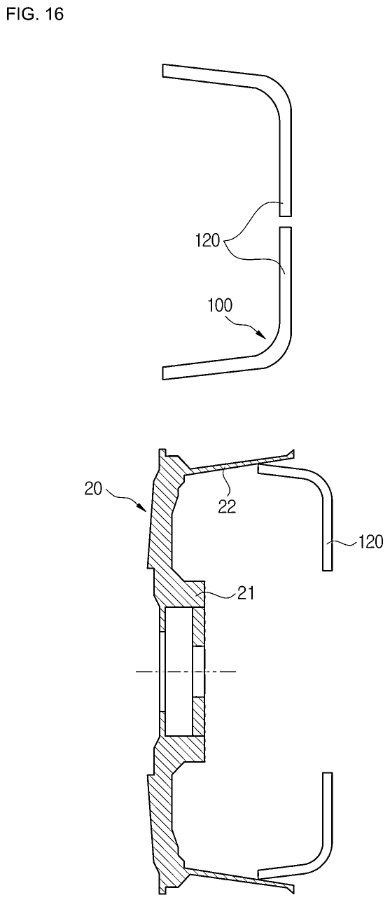

FIG. 16 shows that the shell comprises an inner portion 120, which is configured to cover an axially inner side of the brake disk 11 and the caliper 12. The inner portion 120 is connected to an inner surface of the rim 22 and rotates along with the wheel 20. The axially outer side of the brake disk 11 and caliper 12 may be left without any cover. The inner portion 120 thus provides a half hull for the brake disk 11, leaving half of the brake disk 11, i.e., the outer side, exposed. Optionally, the inner portion 120 may be connected or connectible to the axle 30.

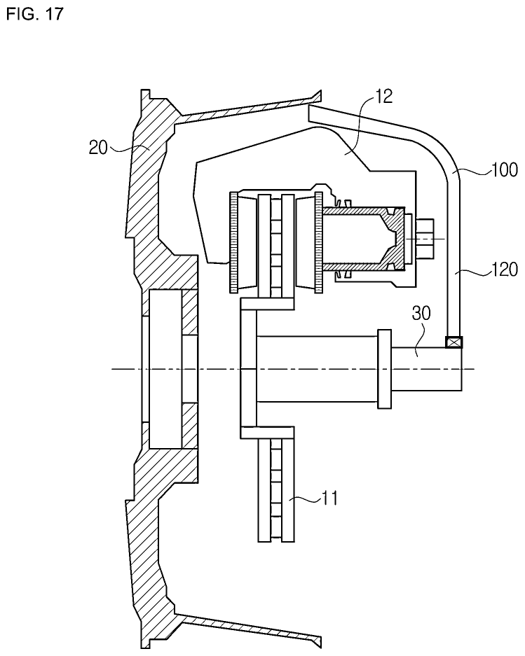

FIGS. 17-20 show embodiments of the brake system, where the shell 100 rotates along with the brake disk 11.

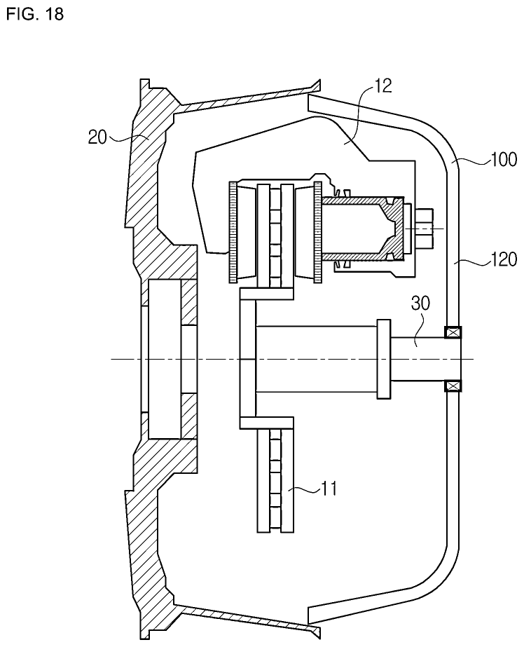

FIGS. 17 and 18 relate to embodiments, where the shell 100 comprises, in each case, only an inner portion 120 that is attached to the axle 30, and no outer portion. In the case of FIG. 17, a quarter hull is provided by way of the inner portion 120 of the shell 100. In the case of FIG. 18 a half hull is provided by way of the inner portion 120 of the shell 100.

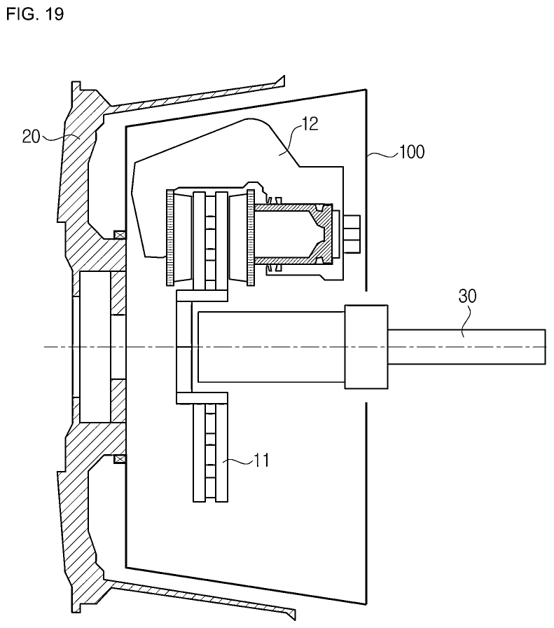

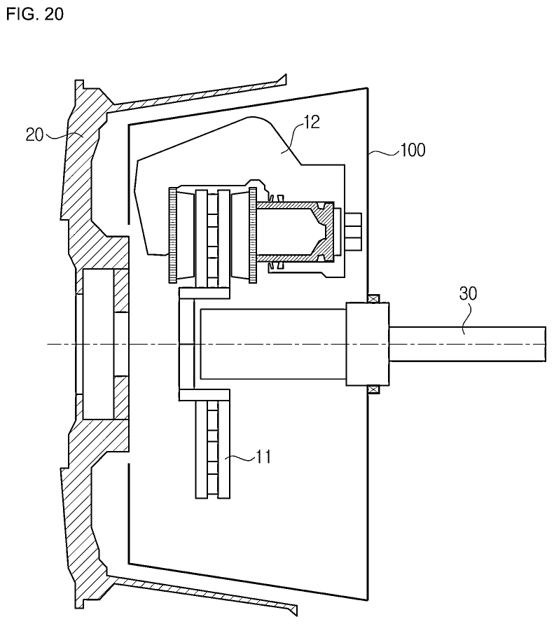

FIGS. 19 and 20 schematically illustrate connection options for attaching the rotating shell 100. According to FIG. 19, the shell 100 may be attached, in particular removably attached, to the wheel hub 21, and there is no connection between the shell 100 and the axle 30. According to FIG. 20, the shell may be attached, in particular removable attached, to the axle 30, and there is no connection between the shell 100 and the wheel 20. In each case, the shell 100 may be composed of several portions or segments that can be disconnected from each other, for disassembling the shell 100.

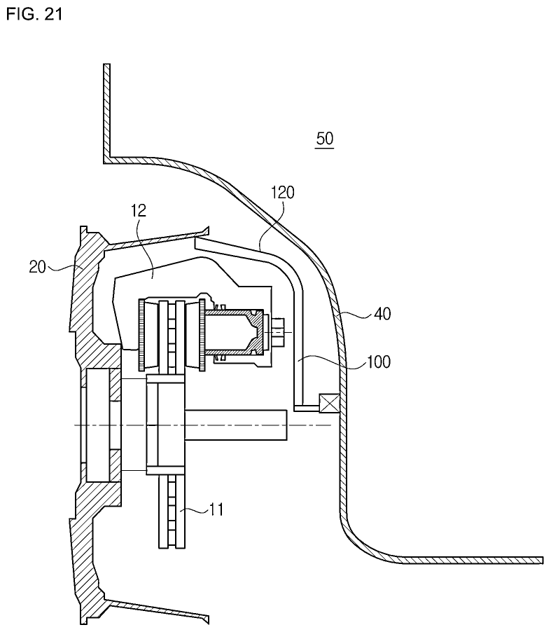

FIGS. 21-26 relate to examples where the shell 100 is configured to be non-rotating, such that the brake disk 11 rotates within the shell 100.

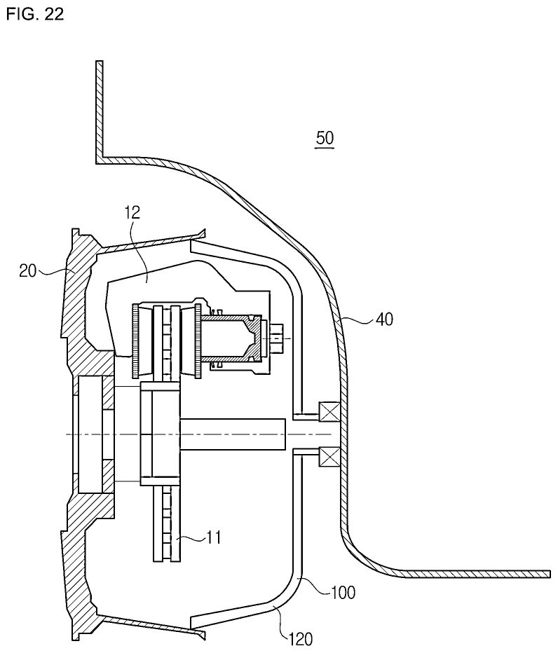

FIGS. 21 and 22 show that the shell 100 is removably attached to a wheel arch 40. In the case of FIG. 21, the shell 100 comprises an inner portion 120, which is in itself composed of one or more inner segments, the inner portion 120 being configured to cover half of the axially inner side of the brake disk 11. The inner portion 120 also covers the caliper 12 on the inner side. In the case of FIG. 22, the shell comprises an inner portion 120, which is in itself composed of one or more inner segments, the inner portion 120 being configured to cover all of the axially inner side of the brake disk 11 and the caliper 12.

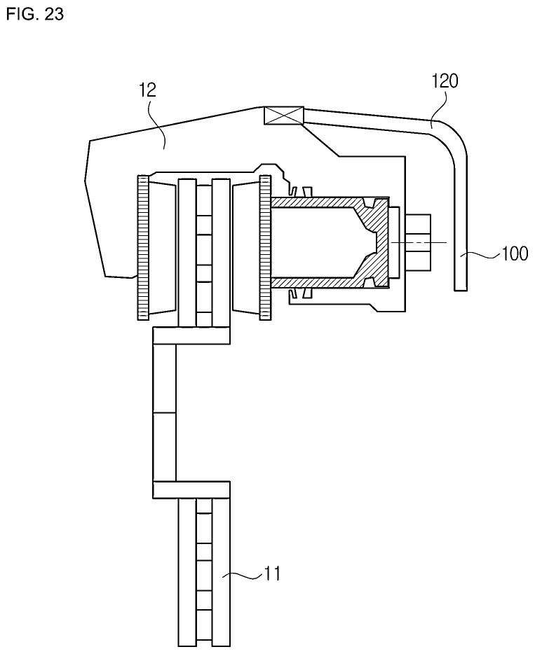

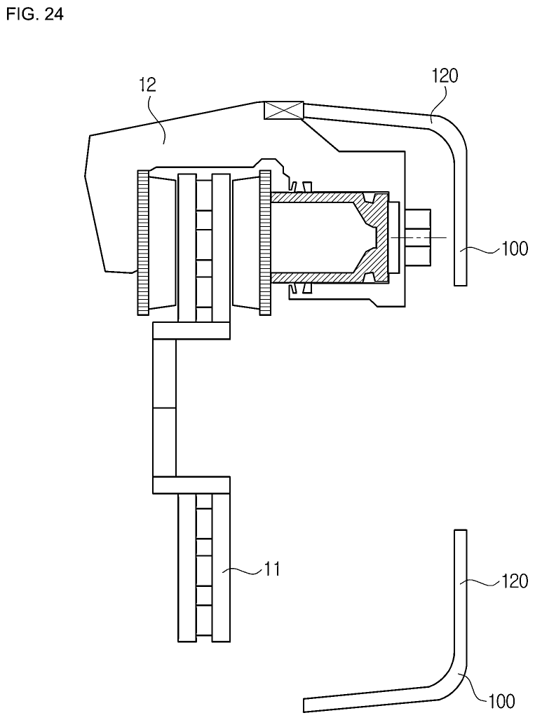

FIGS. 23 and 24 show that the shell 100 is removably attached to the caliper 12. In the case of FIG. 23, the shell 100 comprises an inner portion 120, which is in itself composed of one or more inner segments, the inner portion 120 being configured to cover approximately half of the axially inner side of the brake disk 11, and to cover an inner side of the caliper 12 itself. In the case of FIG. 24, the shell comprises an inner portion 120, which is in itself composed of one or more inner segments, the inner portion 120 being configured to cover all of the axially inner side of the brake disk 11, and to cover an inner side of the caliper 12 itself.

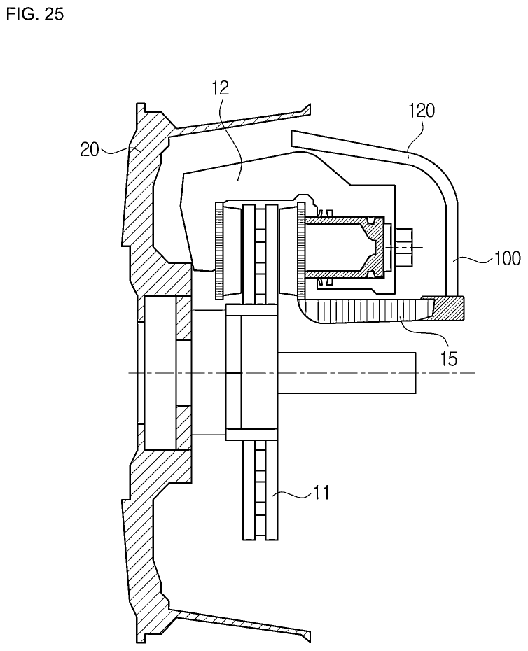

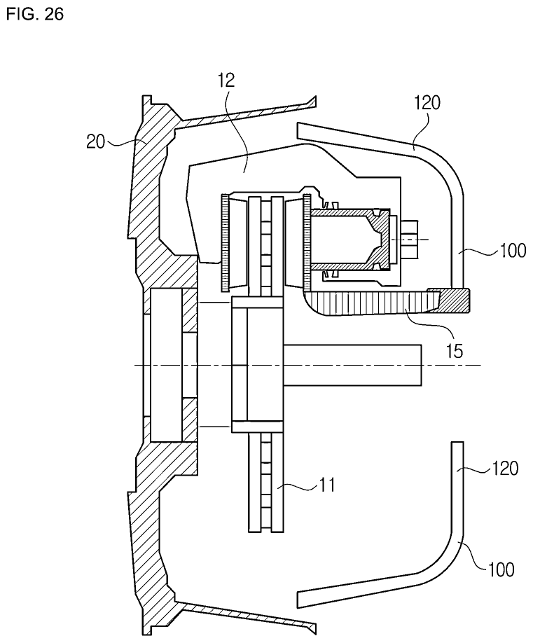

FIGS. 25 and 26 show that the shell 100 is removably attached to a carrier 15 for the caliper 12. In the case of FIG. 25, the shell 100 comprises an inner portion 120, which is in itself composed of one or more inner segments, the inner portion 120 being configured to extend over the inner side of the caliper 12, and cover the inner side of the caliper 12 as well as approximately half of the axially inner side of the brake disk 11. In the case of FIG. 26, the shell 100 comprises an inner portion 120, which is in itself composed of one or more inner segments, the inner portion 120 being configured to cover all of the axially inner side of the brake disk 11, and to cover an inner side of the caliper 12.

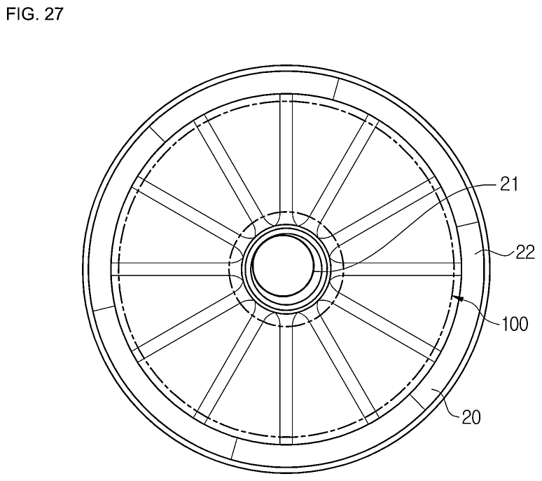

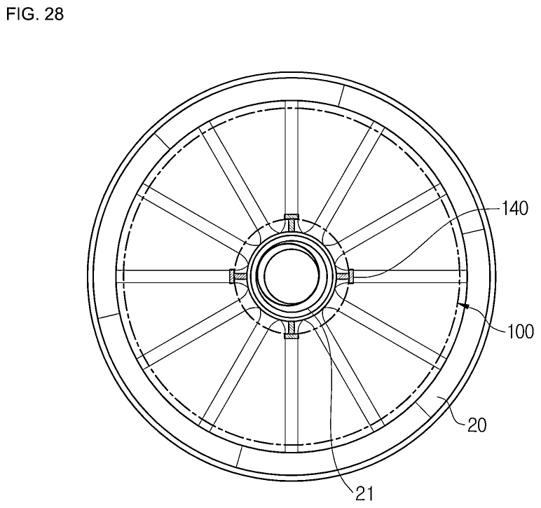

FIGS. 27 and 28 present a view onto a wheel 20, where the positon of the shell 100 according to the present disclosure is indicated. In FIG. 27, boundaries of the shell 100 are schematically shown by dashed-dotted circles. The shell 100 extends in an area between the wheel hub 21 and the rim 22. As shown in FIG. 28, the shell 100 may for instance be connected to the wheel hub 21 by bolts 140.

FIGS. 29-44 show examples for carrying out the shell 100. Therein, views onto the shell 100 are shown. The statements made apply to both the outer portion 110 and the inner portion 120 which may form the shell 100, according to the various embodiments. The portions 110, 120 are composed of segments 111, 112, 113, 114 or 121, 122, 123, 124, each segment covering about a quarter of the respective side of the brake disk 11 on which it is arranged.

According to FIG. 29, the outer portion 110 of the shell 100—as shown for instance in FIGS. 13-15—may comprise a first outer segment 111, a second outer segment 112, a third outer segment 113, and a fourth outer segment 114. In the same way, the inner portion 120 of the shell 100—as shown for instance in FIGS. 15, 16, 18, 22, 24, 26—may comprise a first inner segment 121, a second inner segment 122, a third inner segment 123, and a fourth inner segment 124. The segments may comprise more than one layer, for example two layers. The layers of a segment may be made of different materials from each other. This may aid damping. In an embodiment, the shell 100 is transparent, at least in a section. For instance, one or more of the segments may be transparent.

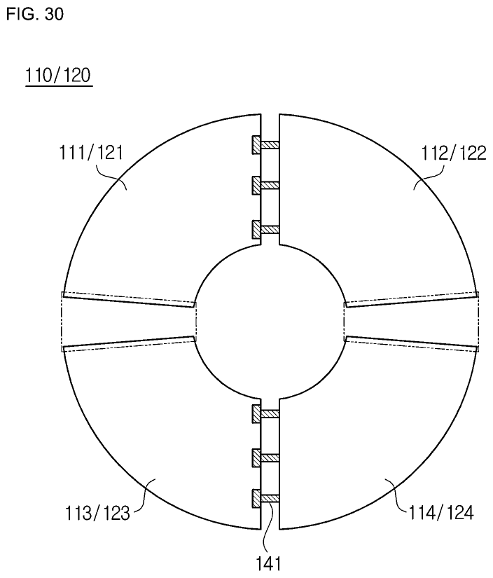

FIG. 30 shows connection options for connecting the segments 111, 112, 113, 114 or 121, 122, 123, 124 to form the outer portion 110 or the inner portion 120. Neighbouring segments are connected by bolts 141 or by way of additional insert elements 142 that are plugged onto the segments.

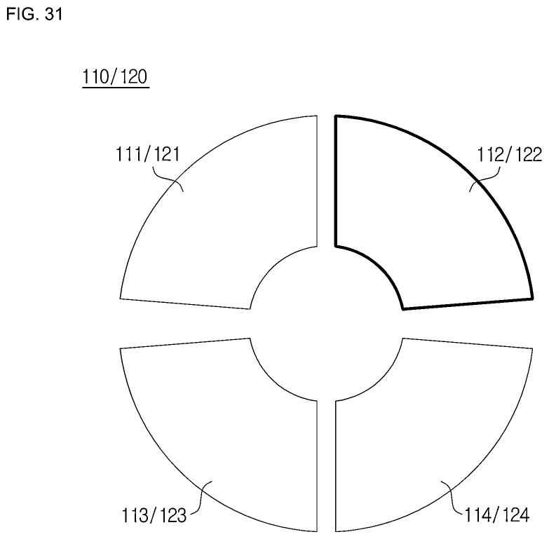

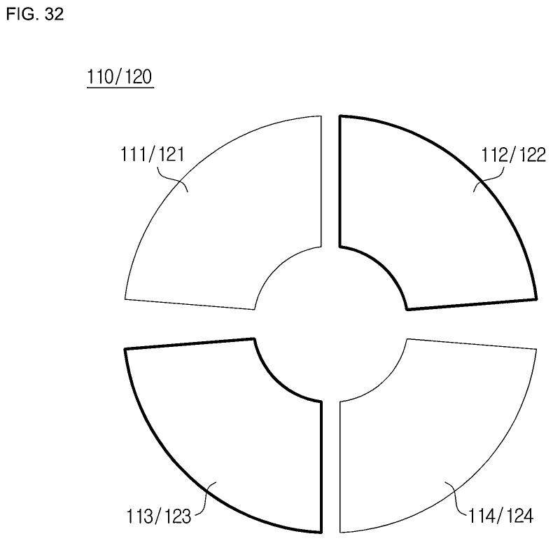

FIG. 31 shows that the second segment 112, 122 is made of a different material than the remaining segments. FIG. 32 shows that the second segment 112, 122 and the third segment 113, 123 are made of a different material than the remaining segments (opposite segments are made of the same material).

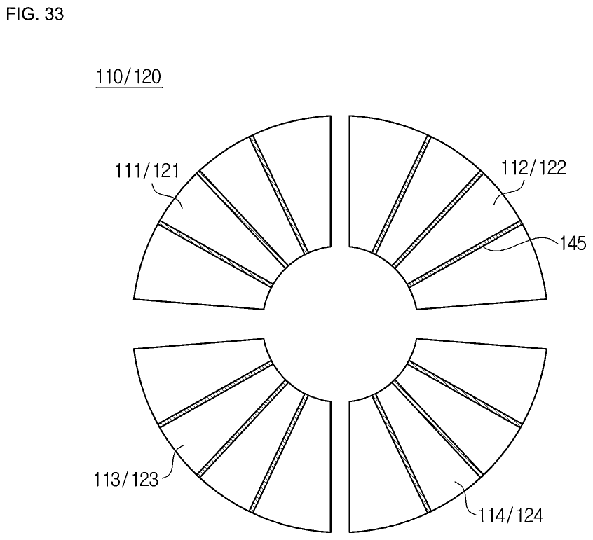

FIG. 33 shows that magnetic inserts 145 are provided within the segments 111, 112, 113, 114 or 121, 122, 123, 124, for adhesion of brake dust. This way, metallic dust can be collected and the environment is protected, even if the shell 100 does not provide a full hull.

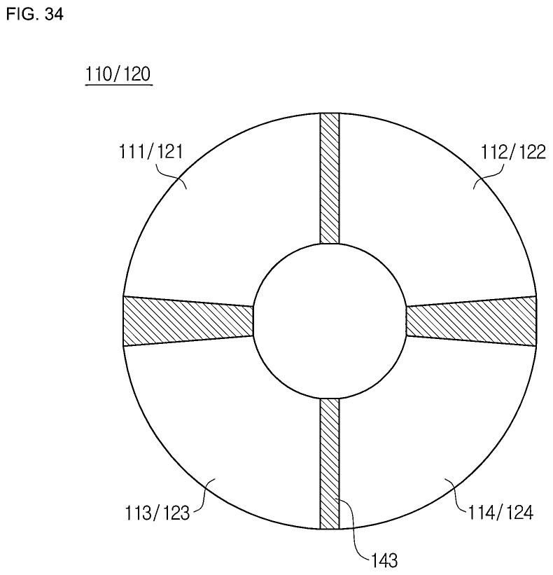

FIG. 34 shows an option for connecting the segments 111, 112, 113, 114 or 121, 122, 123, 124 to each other by plug connections 143.

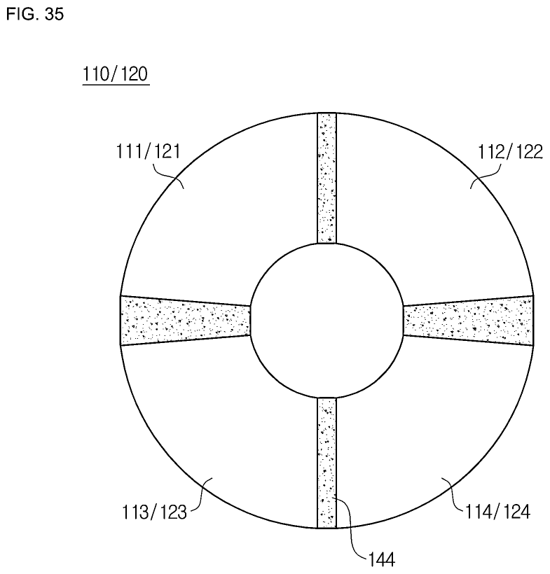

FIG. 35 shows an option for connection the segments 111, 112, 113, 114 or 121, 122, 123, 124 to each other by an adhesive 144.

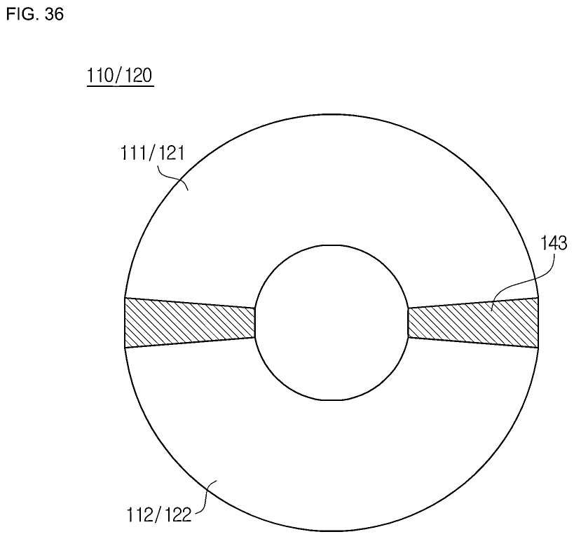

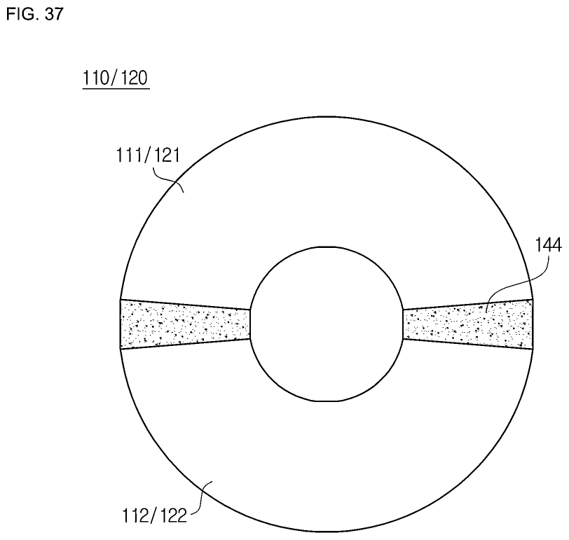

FIGS. 36 and 37 relate to embodiments, where the outer portion 110 or inner portion 120 is composed, in each case, of two segments 111, 112 or 121, 122. FIG. 36 shows connection by way of a plug connection 143. FIG. 37 shows connection by way of an adhesive 144.

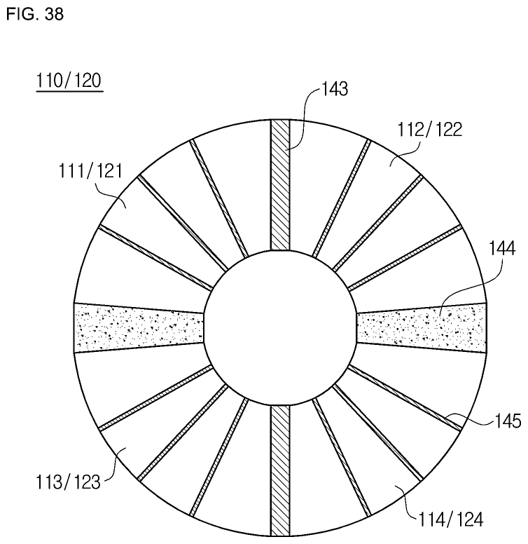

FIG. 38 shows an embodiment where the segments 111, 112, 113, 114 or 121, 122, 123, 124 comprise magnetic inserts 145, wherein both plug connections 143 and adhesive connections 144 are provided for connecting neighbouring segments.

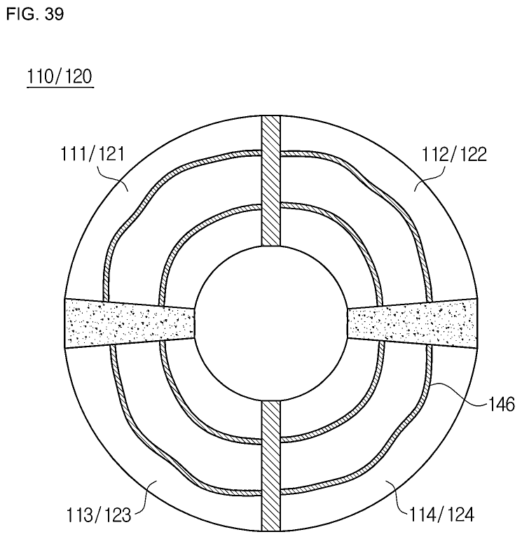

FIG. 39 shows an embodiment, where the shell 100, on the outer portion 110 and/or the inner portion 120, comprises a coating layer 146 for adhesion of brake dust. The coating layer 146 is made of an adhesive material and helps to collect dust emitted from the brake system.

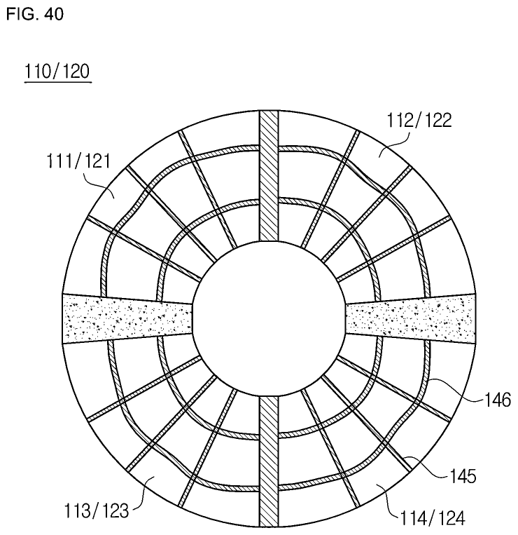

FIG. 40 shows an embodiment, where the where the shell 100, on the outer portion 110 and/or the inner portion 120, comprises both the coating layer 146 for adhesion of brake dust, and the magnetic inserts 145.

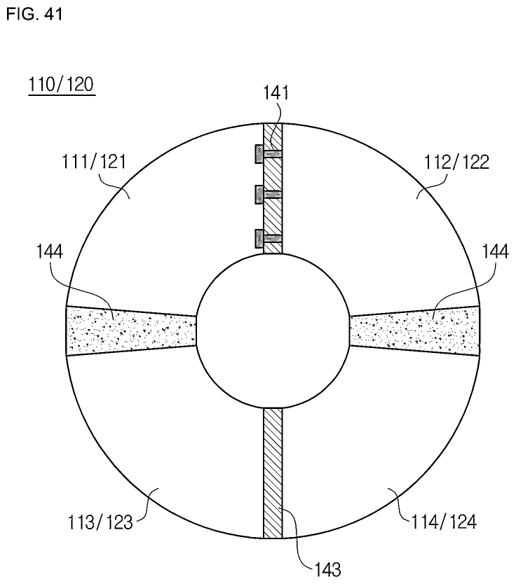

FIG. 41 relates to an embodiment, wherein the first segment 111, 121 is connected to the second segment 112, 122 by way of bolts 141, the second segment 112, 122 is connected to the fourth segment 114, 124 by way of an adhesive 144, the fourth segment 114, 124 is connected to the third segment 113, 123 by way of a plug connection 143, and the third segment 113, 123 is connected to the first segment 111, 121 by way of an adhesive 144.

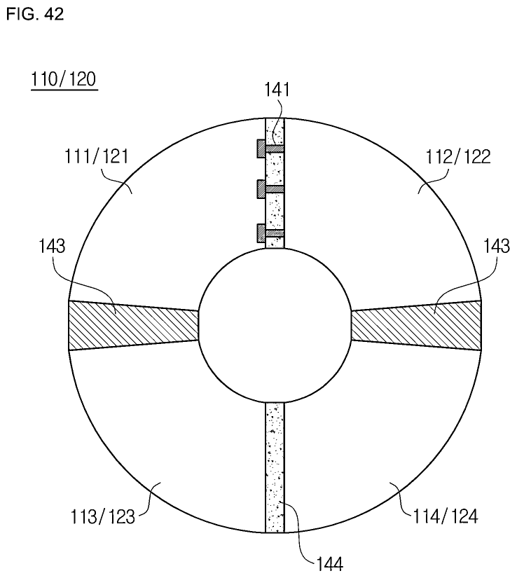

FIG. 42 relates to an embodiment, wherein the first segment 111, 121 is connected to the second segment 112, 122 by way of bolts 141, the second segment 112, 122 is connected to the fourth segment 114, 124 by way of a plug connection 143, the fourth segment 114, 124 is connected to the third segment 113, 123 by way of an adhesive 144, and the third segment 113, 123 is connected to the first segment 111, 121 by way of a plug connection.

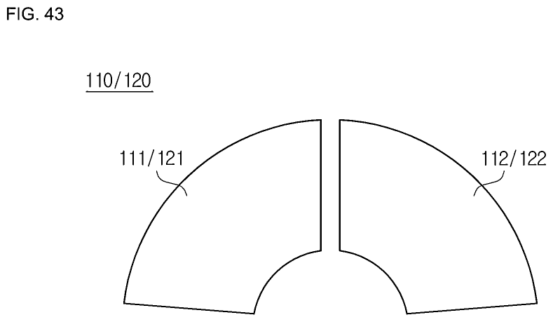

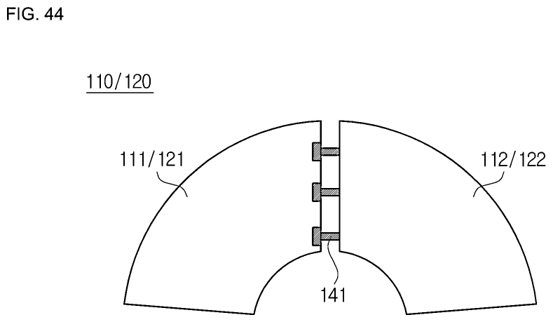

FIGS. 43 and 44 show embodiments, wherein the outer portion 110 is configured to cover only half of the outer side of the brake disk 11 and/or wherein the inner portion 120 is configured to cover only half of the inner side of the brake disk 11. This corresponds for instance to the examples shown in FIG. 12, 14, 17, 21, 23, or 25. The respective portion comprises in each case two segments 111/121 and 112/122, each segment once again covering about a quarter of the respective side. FIG. 44 shows that the segments 111 and 112 or 121 and 122 may be connected by way of bolts 141.

What is claimed is:

1. A disk brake system for a vehicle, comprising a brake disk, a caliper and a shell, the shell at least partially encasing the brake disk, and optionally the caliper, at an axially outer side and/or an axially inner side and/or a circumferentially outer side.

2. The disk brake system according to claim 1, wherein the shell is configured to rotate along with the brake disk, the shell preferably being attached to a wheel and/or an axle.

3. The disk brake system according to claim 1, wherein the shell comprises a first outer segment being configured to cover at least a portion of the axially outer side of the brake disk, wherein the first outer segment is optionally connected to the wheel hub, preferably removably connected to the wheel hub.

4. The disk brake system according to claim 1, wherein the shell comprises a first inner segment, configured to cover at least a portion of the axially inner side of the brake disk.

5. The disk brake system according to claim 4, wherein the shell comprises a first outer segment being configured to cover at least a portion of the axially outer side of the brake disk, wherein the first inner segment is connected to the first outer segment, preferably removably connected to the first outer segment, and/or wherein the first inner segment is connected to a rim and/or to an axle.

6. The disk brake system according to claim 1, wherein the shell is configured to be non-rotating, such that the brake disk rotates within the shell, the shell preferably being configured to be attached to the caliper and/or a carrier for the caliper and/or a wheel arch.

7. The disk brake system according to claim 6, wherein the shell comprises at least a first inner segment configured to cover at least a portion of the axially inner side of the brake disk, the first inner segment being connected, preferably removably connected, to the caliper and/or to the carrier for the caliper and/or to the wheel arch.

8. The disk brake system according to claim 1, wherein the shell comprises a coating layer for adhesion of brake dust.

9. The disk brake system according to claim 1, wherein the shell comprises magnetic inserts for collecting metallic brake dust.

10. The disk brake system according to claim 1, wherein the shell comprises at least two segments that are connected to each other, preferably by an adhesive and/or by at least one bolt and/or by at least one screw.

11. The disk brake system according claim 10, wherein at least two of the at least two segments are made of a different material from each other.

12. The disk brake system according to claim 1, wherein the shell, at least in a section, comprises at least to layers, preferably of different materials from each other.

13. The disk brake system according to claim 1, wherein the shell is transparent, at least in a section.

14. The disk brake system according to claim 1, wherein the shell comprises at least one cleaning opening (130, 131), for rinsing an interior space of the shell and/or for applying suction to the inner space of the shell.

15. The disk brake system according to claim 1, wherein a distance between an inner surface of the shell and the brake disk is at least 10 mm.

16. The disk brake system according to claim 1, wherein the shell only partially encases the axially outer side and/or the axially inner side of the brake disk, leaving at least 25% of an area of the axially inner side and/or an area of the axially outer side of the brake disk exposed.

17. The disk brake system according to claim 1, configured as a brake system for an electric vehicle and/or as a brake system for a rear axle.
